(19) United States
(12) Patent Application Publication
(10) Pub. No.: US 2009/0052599 A1
(43) Pub. Date: Feb. 26, 2009

(54) TRANSMITTER AND TRANSMITTER/RECEIVER

(75) Inventors: Ryogo Yanagisawa, Osaka (JP); Satoshi Takahashi, Osaka (JP); Yoshihiro Tabira, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 12/279,765

(22) PCT Filed: Nov. 30, 2006
(86) PCT No.: PCT/JP2006/323942

§ 371 Date: Aug. 18, 2008

(30) Foreign Application Priority Data
Mar. 1, 2006 (JP) 2006-054453

(51) Int. Cl. H04L 7/00

(52) U.S. Cl. 375/354

(57) ABSTRACT

The present invention provides a transmitter capable of reducing the occurrence of noise when switching from the SD signal to the HD signal, for example. A microcomputer (151) controls a 10-times multiplication PLL (13) to increase the amount of jitter of a multiplied clock (CLK1×10) upon signal switching, i.e., when switching the frequency of an input clock (CLK1) from one to another. Alternatively, it controls a phase adjustment section (31) to increase the amount of jitter of a transmit clock (CLK2). Alternatively, it controls a fixed data producing section (61) to set transmit data (DATA2) to predetermined fixed data stored in a fixed data storing section (62).

### TECHNICAL FIELD

The present invention relates to a transmitter and a transmitter/receiver for digital signals, and more particularly to a transmitter and a transmitter/receiver used for transmitting video signals and audio signals of a STB (Set Top Box), a DVD player, a DVD recorder, or the like.

### BACKGROUND ART

The DVI (Digital Visual Interface) is known in the art as a standard employed by conventional transmitters and transmitters/receivers for transmitting video signals (see, for example, Patent Document 1 for transmitters and transmitters/receivers, and Non-Patent Document 1 for the DVI standard). The HDMI (High Definition Multimedia Interface) standard capable of transmitting a video signal multiplexed with an audio signal is also known in the art, as an extension of the DVI standard (see, for example, Non-Patent Document 2). The HDMI standard is backward compatible with the DVI standard, and basically uses the same transmission/reception method as that of the DVI standard. Therefore, conventional transmitters and conventional transmitters/receivers will be herein described with respect to the DVI standard.

FIG. 8 shows a conventional example of a transmitter and a transmitter/receiver. In FIG. 8, 11 denotes an encoder, 12 a parallel-serial converter, 14 a frequency divider, 16 an MPEG2 decoder, 32 a 10-times multiplication PLL, 17 a serial-parallel converter, 18 a decoder, 19 a clock recovery section, 110 a frequency divider, 111 a TV, 112 a cable, 451 a transmitter, and 114 a receiver, wherein the transmitter 451 and the receiver 114 together form a transmitter/receiver.

While data are transmitted through three channels of R, G and B in the DVI standard, FIG. 8 shows only one channel for the sake of simplicity. Referring to FIG. 8, the conventional transmitter and transmitter/receiver will now be described.

The MPEG2 decoder 16 decodes the MPEG2 data recorded on a DVD disc, for example, to thereby output a clock CLK1 and an 8-bit video signal in synchronism with the clock CLK1 as data DATA1. The encoder 11 performs an 8-bit-10-bit conversion to output 10-bit data. In the 8-bit-10-bit conversion, two bits are added so that “1”s or “0”s will not appear consecutively over a long period while achieving the DC balance when the data is converted to serial data. The 10-bit parallel data is converted by the parallel-serial converter 12 to 1-bit serial data and sent to the cable 112 being a transmission line.

The 10-times multiplication PLL 32 includes a PLL (Phase Locked Loop), and produces a clock CLK1×10 whose frequency is 10 times that of the input clock CLK1. Using the multiplied clock CLK1×10, the parallel-serial converter 12 converts the 10-bit parallel data to 1-bit serial data. The multiplied clock CLK1×10 is converted by the frequency divider 14 to a 1/10 frequency and sent to the cable 112.

Through the above operation, a clock CLK2 of the same frequency as the input clock CLK1, and data DATA2 in synchronism with the multiplied clock CLK1×10 having a frequency that is 10 times that of the input clock CLK1 are sent to the cable 112. Hereinafter, the clock CLK2 and the data DATA2 will be referred to as the “transmit clock” and the “transmit data”, respectively. A clock CLK3 and data DATA3 received by the receiver 114 via the cable 112 will be referred to as the “receive clock” and the “receive data”, respectively.

From the receive clock CLK3 and the receive data DATA3 being 1-bit serial data, which are input via the cable 112, the receiver 114 outputs transmitted 8-bit parallel data DATA4 and a clock CLK4 in synchronism with the data DATA4. Fluctuation in the time axis direction (hereinafter referred to as the “jitter”) is present between the receive clock CLK3 and the receive data DATA3. This is a jitter obtained by adding a jitter occurring along the cable 112 to a jitter between the transmit data DATA2 and the transmit clock CLK2. The clock recovery section 19 multiplies the receive clock CLK3 by 10 to produce, as the multiplied clock CLK3×10, a clock of the ×10 frequency, following the jitter of the receive data DATA3. The serial-parallel converter 17 uses the multiplied clock CLK3×10 to convert the 1-bit serial data to 10-bit parallel data. The decoder 18 performs a 10-bit-8-bit conversion to thereby restore the transmitted 8-bit data DATA4. The frequency divider 110 divides the multiplied clock CLK3×10 to 1/10 to thereby restore the transmitted clock CLK4. Eventually, the data DATA4 and the clock CLK4 are output from the receiver 114 and displayed on the TV 111.

For the clock recovery section 19, a method of Patent Document 2, for example, is known in the art. FIG. 9 shows an example of the clock recovery section 19. In FIG. 9, 461 denotes a 10-times multiplication PLL, 462 a multi-phase generator, 463 an oversampler, and 464 a phase determining section. Referring to FIG. 9, the operation of the clock recovery section 19 will now be described.

The 10-times multiplication PLL 461 produces the clock CLK3×10 whose frequency is 10 times that of the receive clock CLK3. The multi-phase generator 462 shifts the phase of the clock CLK3×10 to produce a plurality of clocks (hereinafter referred to as the “multi-phase clocks”). FIG. 10 shows the relationship between the receive data and the multi-phase clocks. FIG. 10 shows an example where five clocks (hereinafter referred to as the “5-phase clocks”) are produced by the multi-phase generator 462. The 5-phase clocks of FIGS. 10(2) to 10(6) are produced for the receive data of FIG. 10(1). In the case of the 5-phase clocks, the amount of phase shift between clocks is ⅕ of the clock frequency. The phase shifts are given by delay lines, for example.

The oversampler 463 samples the receive data DATA3 with each of the 5-phase clocks. In other words, a ×5 oversampling is performed. Based on the results from the oversampler 463, the phase determining section 464 determines the clock phase with which the receive data DATA3 can be sampled for a largest setup/hold margin, and selectively outputs the clock phase of the largest margin. The degree of margin can be determined by determining whether the point of transition of the receive data is present near the rising edge of the 5-phase clocks. By using a clock thus selected, the serial-parallel converter 17 can stably perform the serial-parallel conversion of the receive data DATA3.

Patent Document 1: Japanese Laid-Open Patent Publication No. 2002-314970

Patent Document 2: Japanese National Phase PCT Laid-Open Publication No. 11-511926

Non-Patent Document 1: “Digital Visual Interface DVI Revision 1.0”, [online], Apr. 2, 1999, DDWG (Digital Display Working Group), [date of search: Feb. 17, 2006], Internet URL: http://www.ddwg.org/lib/dvi_{—}10.pdf

Non-Patent Document 2: “HDMI Retail Training Program Part II: Additional Information”, [online], May 27, 2004, HDMI (High-Definition Multimedia Interface), [date of search: Feb. 17, 2006], Internet URL: http://www.hdmi.org/pdf/HDMIPresPart2.ppt

### DISCLOSURE OF THE INVENTION

Problems To Be Solved By The Invention

The DVI standard defines the transmission of various video formats. For example, a standard signal (hereinafter an “SD signal”; clock frequency: 27 MHz) and a high-vision signal (hereinafter an “HD signal”; clock frequency: 74.175 MHz) can be transmitted. It is also possible to switch from the SD signal to the HD signal in the middle of transmission. When switching from the SD signal to the HD signal, the clock frequency is switched from 27 MHz to 74.175 MHz. Then, in the clock recovery section 19, the phase determining section 464 needs to re-select a clock phase in response to the change in the frequency of the receive clock CLK3.

FIG. 11 shows the relationship between the receive data and the 5-phase clocks. While FIG. 10 shows the time axis in the horizontal direction, FIG. 11 shows it in the vertical direction to illustrate the jitter of the receive data (FIGS. 11(1) to 11(5)). FIG. 11(6) shows the 5-phase clocks only by their rising edges (a, b, c, d and e).

Assuming that the jitter of the receive data DATA3 at the time of frequency change of the receive clock CLK3 is as shown in FIG. 11, the phase determining section 464 selects the clock c (FIG. 11(7)) of the 5-phase clocks, and temporarily stops the operation. However, due to subsequent changes in the ambient temperature and uncertain factors on the transmitter side, etc., the amount of jitter of the receive data DATA3 may increase over time from that at the time of frequency change of the receive clock CLK3. An example of this is shown in FIG. 12. In FIG. 12, if the clock c of the 5-phase clocks remains selected though the clock d of the 5-phase clocks should really be selected, it reduces the margin for the jitter of the receive data DATA3 (FIGS. 12(1) to 12(5)).

Then, in the serial-parallel converter 17, the setup margin or the hold margin between the receive data DATA3 and the output clock CLK3×10 of the clock recovery section 19 decreases, thus making it more likely that mis-latching occurs and garbled data are produced. This continues to be the case until the clock recovery section 19 re-selects the clock phase, and the garbled data is displayed on the TV 111 in the meantime.

Since the time constant of the response of the clock recovery section 19 varies depending on the receiver 114, the amount of time for which noise is displayed on the TV 111 varies depending on the receiver 114. Also when the signal is switched from the HD signal to the SD signal, similar phenomena will occur. Thus, noise is displayed on the TV 111 when the transmitter 451 performs a signal switching that entails a change in the clock frequency.

The phase determining section 464 selects the clock phase based on the point of transition of the receive data DATA3. Therefore, if there are only few points of transition in the data at the time of frequency change of the receive clock CLK3, the possibility for a correct clock phase to be selected is reduced. For example, if “1”s appear contiguously in the receive data DATA3, there is no point of transition from “1” to “0” or from “0” to “1”, whereby the phase determining section 464 cannot select a clock phase during that period. In such a case, even if there is a significant jitter between the receive data DATA3 and the receive clock CLK3, it is not possible to correctly detect this and to select a desirable clock phase. In other words, where there are only few points of “1”/“0” transition in the receive data DATA3 at the time of frequency change of the receive clock CLK3, a significant jitter being present during that period will be masked, thereby failing to select a clock phase in view of a significant jitter. This leads to noise being displayed on the TV 111.

While the description above is directed to the DVI standard, similar phenomena will occur with the HDMI standard. Moreover, similar phenomena will occur not only with the DVI standard or the HDMI standard, but also with the transmission/reception in other similar schemes.

Thus, with a conventional configuration, noise is displayed on the TV on the receiver side when the signal is switched on the transmitter side from the SD signal to the HD signal, for example.

The present invention has been made in view of the problems as set forth above, and has an object to provide a transmitter and a transmitter/receiver, in which it is possible to reduce the occurrence of noise upon signal switching.

Means For Solving The Problems

In order to solve the problem as set forth above, the present invention provides a transmitter, including: a clock multiplication section for receiving an input clock and producing a multiplied clock having a frequency that is N times that of the input clock (N is a natural number), the clock multiplication section being capable of increasing/decreasing an amount of jitter of the multiplied clock; a transmit data producing section for receiving input data and producing, from the input data, transmit data being serial data in synchronism with the multiplied clock; a transmit clock producing section for dividing a frequency of the multiplied clock to 1/N to produce a transmit clock; and a control section for controlling the clock multiplication section so as to increase an amount of jitter of the multiplied clock for a predetermined amount of time upon switching of a frequency of the input clock.

According to the present invention, the clock multiplication section is capable of increasing/decreasing the amount of jitter of the multiplied clock produced, and the amount of jitter of the multiplied clock is increased for a predetermined amount of time, as controlled by the control section, upon switching of the frequency of the input clock. Thus, the amount of jitter between the transmit data and the transmit clock upon switching of the frequency of the input clock is greater than that during a normal operation. Therefore, in the receiver receiving the transmit data and the transmit clock, a more desirable clock phase can be selected and the clock recovery can be performed correctly.

The present invention also provides a transmitter, including: a clock multiplication section for receiving an input clock and producing a multiplied clock having a frequency that is N times that of the input clock (N is a natural number); a transmit data producing section for receiving input data and producing, from the input data, transmit data being serial data in synchronism with the multiplied clock; a transmit clock producing section for dividing a frequency of the multiplied clock to 1/N to produce a transmit clock, the transmit clock producing section being capable of increasing/decreasing an amount of jitter of the transmit clock; and a control section for controlling the transmit clock producing section so as to increase an amount of jitter of the transmit clock for a predetermined amount of time upon switching of a frequency of the input clock.

According to the present invention, the transmit clock producing section is capable of increasing/decreasing the amount of jitter of the transmit clock, and increases the amount of jitter of the transmit clock for a predetermined amount of time as controlled by the control section upon switching of the frequency of the input clock. Thus, the amount of jitter between the transmit data and the transmit clock upon switching of the frequency of the input clock is greater than that during a normal operation. Therefore, in the receiver receiving the transmit data and the transmit clock, a more desirable clock phase can be selected and the clock recovery can be performed correctly.

The present invention also provides a transmitter, including: a clock multiplication section for receiving an input clock and producing a multiplied clock having a frequency that is N times that of the input clock (N is a natural number); a transmit data producing section for receiving input data and producing, from the input data, transmit data being serial data in synchronism with the multiplied clock, wherein the transmit data can be set to predetermined fixed data; a transmit clock producing section for dividing a frequency of the multiplied clock to 1/N to produce a transmit clock; and a control section for controlling the transmit data producing section so as to set the transmit data to the predetermined fixed data for a predetermined amount of time upon switching of a frequency of the input clock, wherein the predetermined fixed data is such data that a frequency of transitions from “1” to “0” or from “0” to “1” in the transmit data becomes higher than that during a normal operation.

According to the present invention, the transmit data producing section is capable of setting the transmit data to the predetermined fixed data, and sets the transmit data to the predetermined fixed data for a predetermined amount of time as controlled by the control section upon switching of the frequency of the input clock. The predetermined fixed data is such data that the frequency of transitions from “1” to “0” or from “0” to “1” in the transmit data becomes higher than that during a normal operation. Thus, it is possible to increase the frequency of transitions between “0”s and “1”s in the transmit data from that during a normal operation upon switching of the frequency of the input clock. Therefore, in the receiver receiving the transmit data and the transmit clock, a more desirable clock phase can be selected and the clock recovery can be performed correctly.

The present invention also provides a transmitter, including: a clock multiplication section for receiving an input clock and producing a multiplied clock having a frequency that is N times that of the input clock (N is a natural number); a transmit data producing section for receiving input data representing a video signal and producing, from the input data, transmit data being serial data in synchronism with the multiplied clock, wherein the input data can be set to predetermined fixed data; a transmit clock producing section for dividing a frequency of the multiplied clock to 1/N to produce a transmit clock; and a control section for controlling the transmit data producing section so that data of the input data excluding retrace periods is set to the predetermined fixed data for a predetermined amount of time upon switching of a frequency of the input clock; wherein the predetermined fixed data is such data that a frequency of transitions from “1” to “0” or from “0” to “1” in the transmit data becomes higher than that during a normal operation.

According to the present invention, the transmit data producing section is capable of setting the input data representing a video signal to the predetermined fixed data, and sets data of the input data excluding retrace periods to the predetermined fixed data for a predetermined amount of time as controlled by the control section upon switching of the frequency of the input clock. The predetermined fixed data is such data that the frequency of transitions from “1” to “0” or from “0” to “1” in the transmit data becomes higher than that during a normal operation. Thus, it is possible to increase the frequency of transitions between “0”s and “1”s in the transmit data from that during a normal operation upon switching of the frequency of the input clock. Therefore, in the receiver receiving the transmit data and the transmit clock, a more desirable clock phase can be selected and the clock recovery can be performed correctly.

The present invention also provides a transmitter/receiver, including: any of transmitters of the present invention as set forth above; and a receiver for receiving the transmit data and the transmit clock transmitted from the transmitter as receive data and a receive clock, respectively; wherein the receiver includes: a clock recovery section for reproducing, from the receive data and the receive clock, a multiplied clock being in synchronism with the receive data and having a frequency that is N times that of the receive clock; and frequency change detecting means for detecting a switching of a frequency of the receive clock to initialize the clock recovery section upon detection.

According to the present invention, in the receiver, the clock recovery section is initialized when the frequency change detecting means detects a switching of the frequency of the receive clock. Thus, it is possible to shorten the amount of time required before a correct clock phase is selected.

Effects Of The Invention

According to the present invention, upon switching of the frequency of the input clock, the amount of jitter between the transmit data and the transmit clock can be increased from that during a normal operation. Moreover, upon switching of the frequency of the input clock, the frequency of transitions between “0”s and “1”s in the transmit data can be increased from that during a normal operation. Thus, when the signal is switched from one to another on the transmitter side, the clock recovery can be operated correctly in the receiver, which receives the transmit data and the transmit clock. Therefore, it is possible to reduce noise displayed on the TV on the receiver side.

### BRIEF DESCRIPTION OF THE DRAWINGS

FIG. 1 is a block diagram showing a configuration including a transmitter according to a first embodiment of the present invention.

FIG. 2 is a block diagram showing a specific exemplary configuration of a 10-times multiplication PLL in the configuration of FIG. 1.

FIG. 3 is a block diagram showing a specific exemplary configuration of a phase adjustment section in the configuration of FIG. 1.

FIG. 4 is a diagram showing the clock recovery operation in the first embodiment of the present invention.

FIG. 5 is a block diagram showing a configuration including a transmitter according to a second embodiment of the present invention.

FIG. 6 is a block diagram showing a configuration including a transmitter according to a third embodiment of the present invention.

FIG. 7 is a block diagram showing a configuration including a transmitter/receiver according to a fourth embodiment of the present invention.

FIG. 8 is a block diagram showing a configuration including a conventional transmitter.

FIG. 9 is a block diagram showing a specific exemplary configuration of a clock recovery section.

FIG. 10 is a waveform diagram showing the operation of the clock recovery section of FIG. 9.

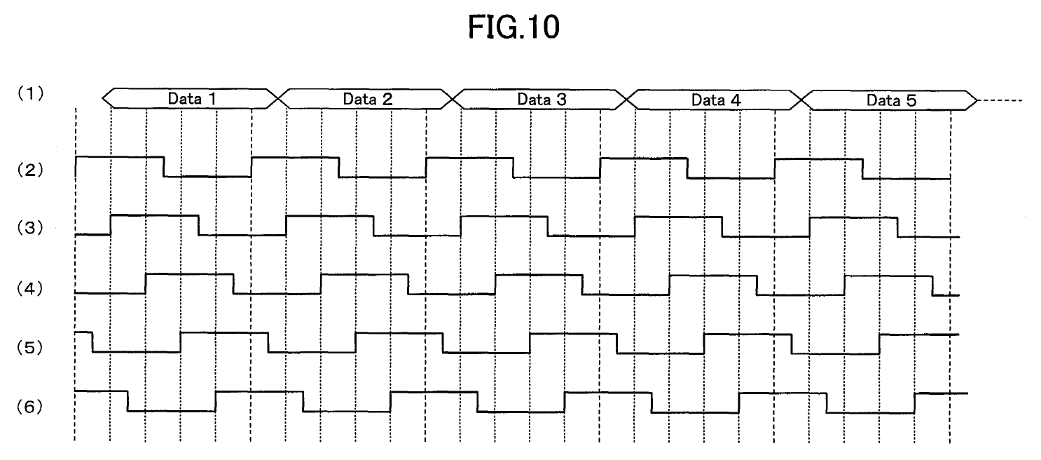

FIG. 11 is a diagram illustrating a conventional clock recovery operation.

FIG. 12 is a diagram illustrating a conventional clock recovery operation.

### DESCRIPTION OF REFERENCE NUMERALS

11 Encoder

12 Parallel-serial conversion section

13 10-times multiplication PLL (clock multiplication section)

14 Frequency divider

19 Clock recovery section

21 Phase comparator

22 LPF

23 LPF

24 VCO

25 Frequency divider

26 Selection circuit

31 Phase adjustment section

41, 42, 43 Delay line

44, 45 Selection circuit

61 Fixed data producing section

71 Mute signal producing section

101 Remote controller

114, 243 Receiver

151, 161, 221 Microcomputer (control section)

152, 162, 222 Transmitter

171 EDID

223 Read-out means

241 Frequency change detecting means

242 Clock recovery section

### BEST MODE FOR CARRYING OUT THE INVENTION

Embodiments of the present invention will now be described with reference to the drawings. The following description is directed to the DVI standard, as an example. While data are transmitted through three channels in the DVI standard or the HDMI standard, the following description is directed to a case of a single-channel transmission for the sake of simplicity.

### First Embodiment

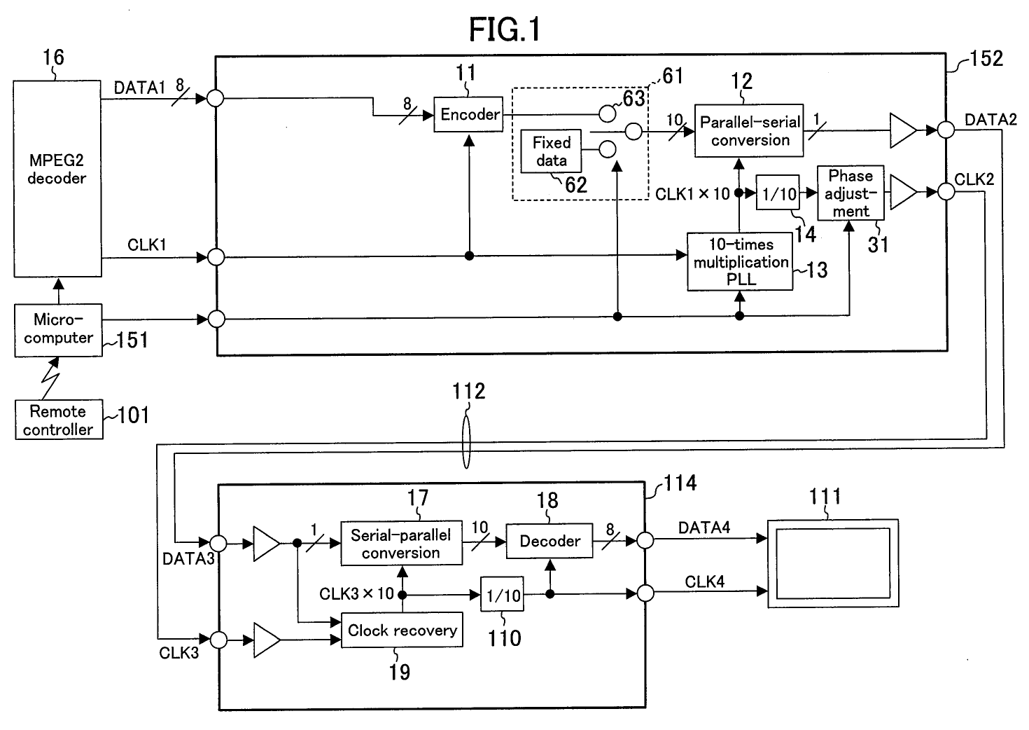

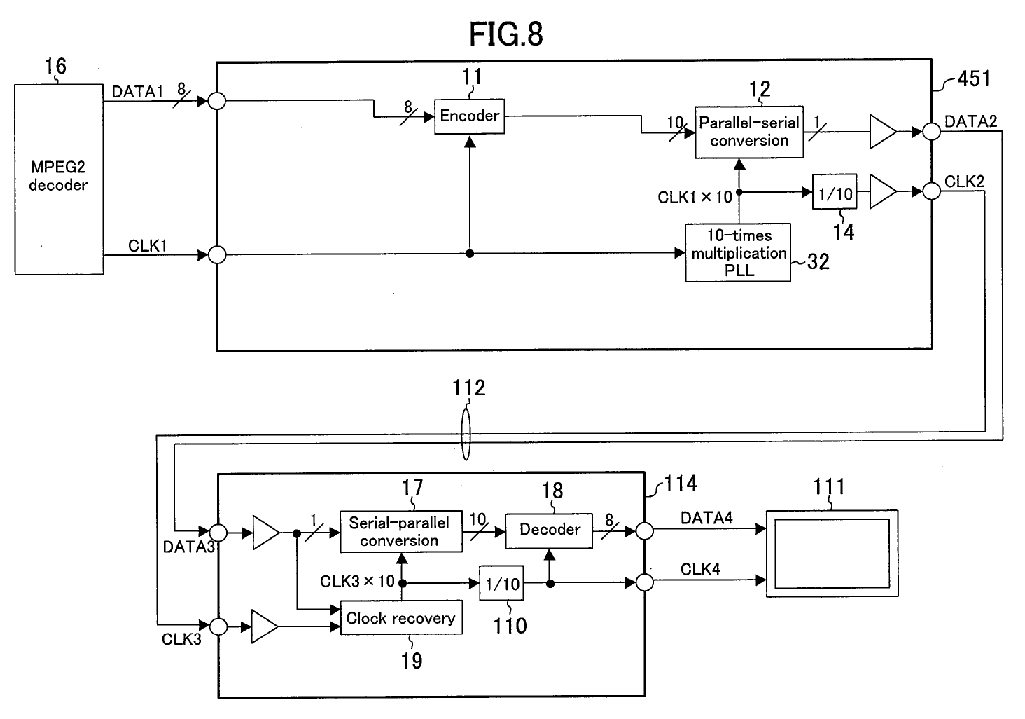

FIG. 1 is a block diagram showing a configuration including a transmitter according to a first embodiment of the present invention. In FIG. 1, like elements to those of FIG. 8 described above in the background art section are denoted by like reference numerals to those in FIG. 8, and will not be further described below. A transmitter 152 includes, instead of the 10-times multiplication PLL 32, a 10-times multiplication PLL 13 capable of producing a multiplied clock CLK1×10 having a frequency that is N times that of an input clock CLK1 (N is a natural number; herein N=10) and increasing/decreasing the amount of jitter of the multiplied clock CLK1×10. Moreover, the transmitter 152 includes a phase adjustment section 31 capable of increasing/decreasing the amount of phase shift, i.e., the amount of jitter, of the transmit clock produced by the frequency divider 14, and a fixed data producing section 61 capable of setting the output of the encoder 11 to be fixed data. A microcomputer 151 as the control section controls the 10-times multiplication PLL 13, the phase adjustment section 31 and the fixed data producing section 61. The microcomputer 151 operates based on information from a remote controller 101.

The 10-times multiplication PLL 13 forms a clock multiplication section; the encoder 11, the parallel-serial conversion section 12 and the fixed data producing section 61 together form a transmit data producing section; and the frequency divider 14 and the phase adjustment section 31 together form a transmit clock producing section.

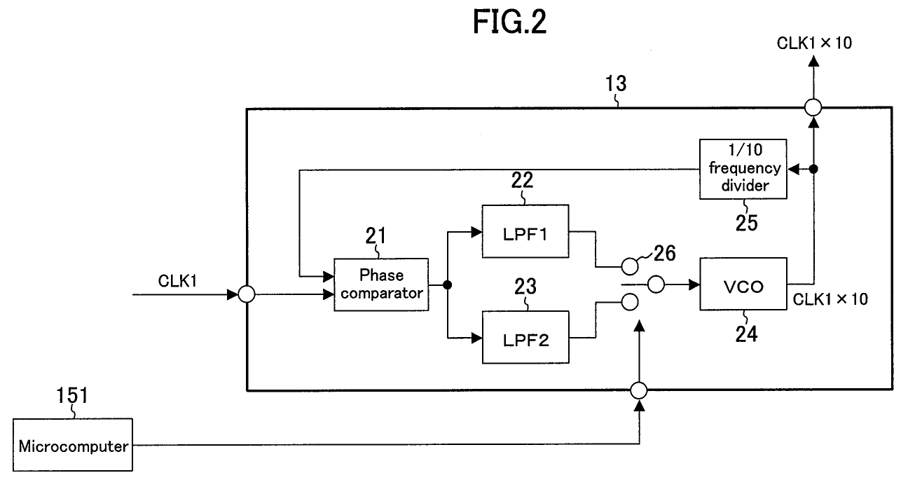

FIG. 2 shows a specific exemplary configuration of the 10-times multiplication PLL 13. In FIG. 2, 21 denotes a phase comparator, 22 and 23 low-pass filters (hereinafter referred to as “LPFs”), 24 a voltage-controlled oscillator (hereinafter referred to as a “VCO”), 25 a frequency divider, and 26 a selection circuit. The phase comparator 21 and the frequency divider 25 together form a phase comparison section, and the LPFs 22 and 22 and the selection circuit 26 together form a filter section.

The VCO 24 oscillates to output the multiplied clock CLK1×10 having a frequency that is 10 times that of the input clock CLK1. The multiplied clock CLK1×10 is supplied to the parallel-serial converter 12 and the frequency divider 14. The multiplied clock CLK1×10 is divided to 1/10 by the frequency divider 25 and compared with the input clock CLK1 by the phase comparator 21. The comparison result is applied to the VCO 24 after removing higher harmonics through the LPF 22 or the LPF 23. Thus, the phase comparator 21, the LPFs 22 and 23, the VCO 24 and the frequency divider 25 together form a PLL to produce the multiplied clock CLK1×10 whose phase is synchronized with that of the input clock CLK1.

According to an instruction from the microcomputer 151, the selection circuit 26 selects one of the output of the LPF 22 and that of the LPF 23 and gives the selected output to the VCO 24. It is assumed herein that the passband of the LPF 23 is broader than that of the LPF 22. Thus, the filter section formed by the LPFs 22 and 22 and the selection circuit 26 switches the passband thereof from one to another according to an instruction from the microcomputer 151. The configuration of the filter section capable of switching the passband thereof from one to another is not limited to that shown in FIG. 2, but there are many other possible configurations.

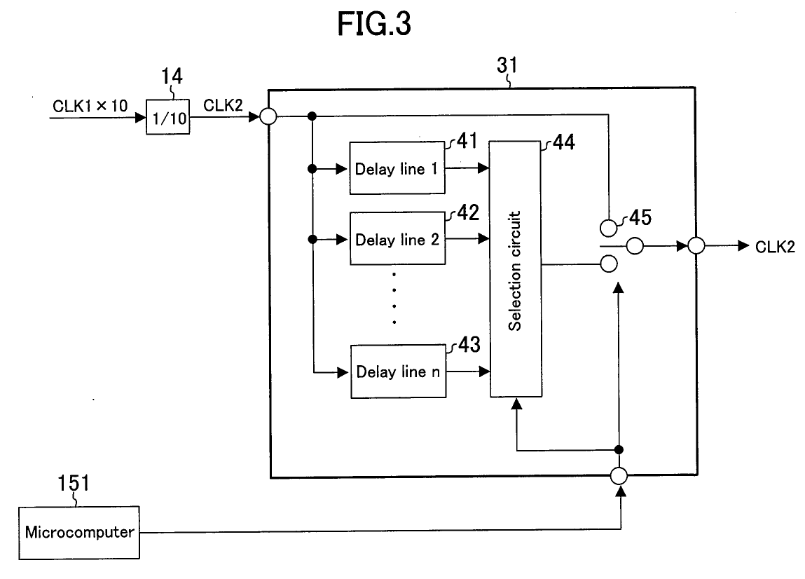

FIG. 3 shows a specific exemplary configuration of the phase adjustment section 31. In FIG. 3, 41, 42, . . . , 43 denote delay lines, and 44 and 45 selection circuits. The delay lines 41, 42, . . . , 43 each have a different delay value. According to an instruction from the microcomputer 151, the selection circuit 44 selects one of the outputs of the delay lines 41, 42, . . . , 43. The selection circuit 45 selects one of the transmit clock CLK2, which passes through no delay lines, and the output of the selection circuit 44. With such a configuration, the phase adjustment section 31 is capable of adding a plurality of different delay amounts to the transmit clock CLK2.

The fixed data producing section 61 includes a fixed data storing section 62 and a selection circuit 63. The predetermined fixed data stored in the fixed data storing section 62 is herein assumed to be an alternating string of “1”s and “0”s. For example, it is 10-bit data whose binary representation is “1010101010”. According to an instruction from the microcomputer 151, the selection circuit 63 selects one of the output of the encoder 11 and the predetermined fixed data stored in the fixed data storing section 62. When the predetermined fixed data is output, the transmit data DATA2 output from the parallel-serial converter 12 is “1010101010101010 . . . ”, alternating “1”s and “0”s with each other at a frequency that is 10 times that of the transmit clock CLK2.

The operation of the configuration of FIGS. 1 to 3 will be described.

Based on an instruction from the microcomputer 151, an SD signal or an HD signal is output from the MPEG2 decoder 16. An HD signal may be produced from an SD signal by an up-converter.

For example, where the signal is switched from the SD signal to the HD signal, the microcomputer 151 controls the 10-times multiplication PLL 13 to increase the amount of jitter of the multiplied clock CLK1×10 at the point of signal transition, i.e., when switching the frequency of the input clock CLK1 from one to another.

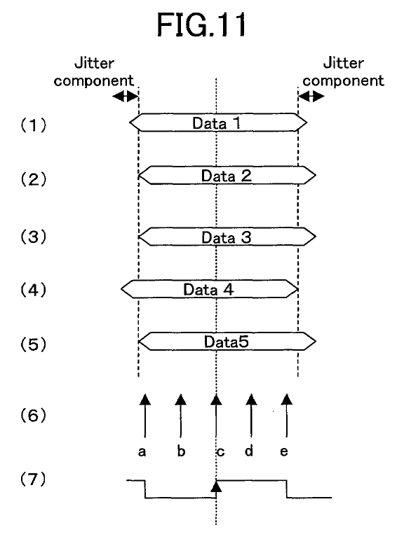

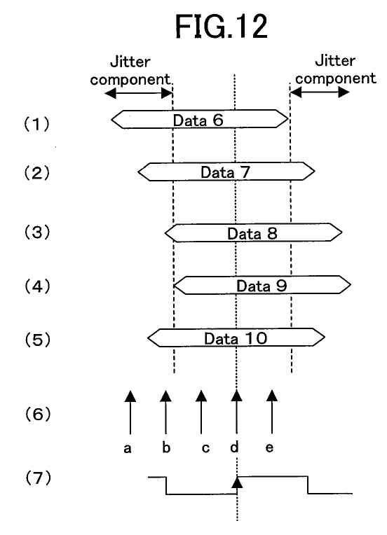

Referring to FIG. 2, during a normal operation, the microcomputer 151 controls the selection circuit 26 to select the output of the LPF 22. It is assumed herein that the average amount of jitter is as shown in FIG. 11 and the maximum amount of jitter is as shown in FIG. 12. Upon signal switching, the microcomputer 151 controls the selection circuit 26 to select the output of the LPF 23. Since the passband of the LPF 23 is broader than that of the LPF 22, noise in the low-frequency range increases from that during a normal operation in the output given to the VCO 24. As a result, this increases the amount of jitter of the multiplied clock CLK1×10 oscillated from the VCO 24. Thus, it is possible to increase the amount of jitter of the multiplied clock CLK1×10 upon signal switching from that during a normal operation.

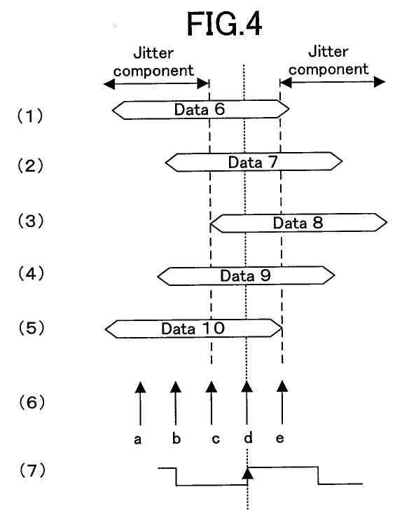

FIG. 4 shows the relationship between the receive data (FIGS. 4(1) to 4(5)) and the 5-phase clocks (FIG. 4(6)) when the LPF 23 is selected and the amount of jitter is increased. Since data is transmitted at a frequency that is 10 times that of the clock, the amount of jitter of the receive data is increased from that when the LPF 22 is selected due to the influence of the characteristics of the cable 112. If the passband of the LPF 23 is set to be sufficiently broader than that of the LPF 22, a sufficiently larger amount of jitter than the maximum amount of jitter shown in FIG. 12 can be applied, as shown in FIG. 4. Then, a clock of the correct phase (FIG. 4(7)) is selected by the clock recovery section 19. Thus, the passband of the filter section is increased to temporarily increase the jitter of the transmit clock CLK2, thereby preventing the clock recovery section 19 from locking at an inappropriate position. Thereafter, the selection circuit 26 can be controlled by the microcomputer 151 to select the output of the LPF 22, in which case a stable operation is realized with the amount of jitter being decreased during a normal operation.

For example, where the signal is switched from the SD signal to the HD signal, the microcomputer 151 controls the phase adjustment section 31 to increase the amount of jitter of the transmit clock CLK2 at the point of signal transition, i.e., when switching the frequency of the input clock CLK1 from one to another.

The amount of jitter added by the phase adjustment section 31 is to be “Jitter component” shown in FIG. 4. It is clear that this “Jitter component” is eventually equal to that when selecting the delay line having the largest delay value during selecting the delay lines 41, 42 and 43 at random. Therefore, it is obvious that selecting fixedly the delay line having the largest delay value instead of selecting the delay lines 41, 42 and 43 at random, achieves the same effect.

Referring to FIG. 3, during a normal operation, the microcomputer 151 controls the selection circuit 45 so as to output the output of the frequency divider 14 as it is as the transmit clock CLK2. Then, in the phase adjustment section 31, no phase shift is added to the transmit clock CLK2. Then, upon signal switching, the microcomputer 151 controls the selection circuits 44 and 45 to randomly select one of the outputs of the delay lines 41, 42, . . . , 43. With the delay lines 41, 42, . . . , 43 each having a different delay value, this makes the amount of delay of the transmit clock CLK2 to change randomly, whereby the transmit clock CLK2 is phase-shifted randomly. Thus, jitter can be randomly added to the transmit clock CLK2 with respect to the transmit data DATA2.

The amount of jitter added by the phase adjustment section 31 can be set to be sufficiently larger than the maximum amount of jitter during a normal operation. For example, assuming that the maximum amount of jitter during a normal operation is as shown in FIG. 12, the clock recovery section 19 can be operated correctly by adding jitter as shown in FIG. 4 by the phase adjustment section 31. Thereafter, the selection circuit 45 can be controlled by the microcomputer 151 so as to output the output of the frequency divider 14 as it is as the transmit clock CLK2, in which case a stable operation is realized with the amount of jitter being decreased during a normal operation.

While the above description is directed to a case where the microcomputer 151 controls the selection circuits 44 and 45 so as to randomly select one of the outputs of the delay lines 41, 42, . . . , 43, similar effects can be obtained also when constantly selecting one of the outputs of the delay lines 41, 42, . . . , 43, with a sufficiently larger jitter than the maximum amount of jitter during a normal operation being added.

For example, where the signal is switched from the SD signal to the HD signal, the microcomputer 151 controls the fixed data producing section 61 to substitute the transmit data DATA2 with the fixed data at the point of signal transition, i.e., when switching the frequency of the input clock CLK1 from one to another. More specifically, the microcomputer 151 controls the selection circuit 63 so that the input to the parallel-serial conversion section 12 is switched from the output of the encoder 11 to the predetermined data stored in the fixed data storing section 62.

In the DVI standard, a conversion such that the number of alternations between “1”s and “0”s is decreased is performed in the 8-bit-10-bit conversion by the encoder 11 so as to reduce the frequency of alternations between “1”s and “0”s along the transmission line 112. For example, a conversion is performed so that there are three or less points of transition from “1” to “0” or from “0” to “1” over 10 bits. Thus, substituting the transmit data with fixed data being an alternating string of “1”s and “0”s increases the frequency of transitions from “1” to “0” or from “0” to “1”. As a result, it is possible to avoid a phenomenon where significant jitters are undesirably masked as described above in the problems to be solved section. Thus, the clock recovery section 19 can be operated correctly. Thereafter, the microcomputer 151 can control the selection circuit 63 so that the output of the encoder 11 is transmitted.

While the above description is directed to a case where the signal is switched from the SD signal to the HD signal, the 10-times multiplication PLL 13, the phase adjustment section 31 and the fixed data producing section 61 can be controlled similarly by the microcomputer 151 also when the signal is switched from the HD signal to the SD signal.

Thus, according to the present embodiment, a clock and data with a larger amount of jitter than that during a normal operation are transmitted upon signal switching, whereby the clock recovery section 19 of the receiver 114 can be operated correctly. Moreover, fixed data is used as the transmit data upon signal switching so as to increase the frequency of transitions between “0” and “1” from that during a normal operation, whereby the clock recovery section 19 of the receiver 114 can be operated correctly. Therefore, it is possible to prevent noise from being displayed on the TV 111.

While the above description is directed to a case where the output of the frequency divider 14 is phase-shifted by the phase adjustment section 31, similar effects can be obtained also when the phase adjustment section 31 precedes the frequency divider 14, wherein the output of the 10-times multiplication PLL 13 is phase-shifted and divided to 1/10 by the frequency divider 14 so as to be transmitted as the transmit clock. Similar effects can be obtained also with a configuration in which the transmit data, instead of the transmit clock, is phase-shifted, whereby the transmit clock is jittered relative to the transmit data.

It is herein assumed that the predetermined fixed data stored in the fixed data storing section 62 is an alternating string of “1”s and “0”s. However, the present invention is not limited to this, and it may be any data as long as the frequency of transitions from “1” to “1” or from “0” to “1” in the transmit data is higher than that during a normal operation in which the frequency of the input clock CLK1 is not switched.

While the present embodiment is directed to a case where the 10-times multiplication PLL 13, the phase adjustment section 31 and the fixed data producing section 61 are each controlled, one of them or any combination of two of them may be controlled. For example, the phase adjustment section 31 and the fixed data producing section 61 may be omitted from the configuration of FIG. 1, wherein only the 10-times multiplication PLL 13 is controlled by the microcomputer 151. Alternatively, the 10-times multiplication PLL 13 may be replaced by a conventional 10-times multiplication PLL and the fixed data producing section 61 may be omitted from the configuration of FIG. 1, wherein only the phase adjustment section 31 is controlled by the microcomputer 151. Alternatively, the 10-times multiplication PLL 13 may be replaced by a conventional 10-times multiplication PLL and the phase adjustment section 31 may be omitted from the configuration of FIG. 1, wherein only the fixed data producing section 61 is controlled by the microcomputer 151. Alternatively, the fixed data producing section 61 may be omitted from the configuration of FIG. 1, for example, wherein the 10-times multiplication PLL 13 and the phase adjustment section 31 are controlled by the microcomputer 151.

Moreover, in the present embodiment, the microcomputer 151 receives information on the receiver 114 from the remote controller 101 so as to set a predetermined amount of time for which the amount of jitter of the multiplied clock is increased, a predetermined amount of time for which the amount of jitter of the transmit clock is increased, and a predetermined amount of time for which the transmit data is substituted with fixed data.

First, the user of the transmitter 152 and the receiver 114 uses the remote controller 101 to specify the product manufacturer, i.e., the manufacturer, of the receiver 114. For example, a graphical user interface (hereinafter referred to as a “GUI”) is used to select one from among a list of product manufacturers. The microcomputer 151 processes the GUI to determine the product manufacturer of the receiver 114. The microcomputer 151 has a table defining the correspondence between product manufacturers and predetermined amounts of time for which the amount of jitter of the multiplied clock is increased, and the predetermined amount of time is determined according to the specified product manufacturer. For example, it may be determined to be 100 msec for Product Manufacturer A and 200 msec for Product Manufacturer B. Therefore, the amount of time for which the amount of jitter of the multiplied clock is increased is optimized for each product manufacturer of the receiver 114. Moreover, the predetermined amount of time for which the amount of jitter of the transmit clock is increased and the predetermined amount of time for which the transmit data is substituted with fixed data can similarly be determined and thus optimized. Thus, the amount of time until a normal image is displayed on the TV 111 is shortened, thereby optimizing the image-output time required before an image is output to the TV 111.

While it is herein assumed that the remote controller 101 is used to specify the product manufacturer of the receiver 114, it may be used to specify the model name, the common name, etc., for example. Thus, the remote controller 101 may be used to specify any information as long as the information specifies the receiver 114.

Instead of using information on the receiver 114, the predetermined amount of time for which the amount of jitter of the multiplied clock is increased, the predetermined amount of time for which the amount of jitter of the transmit clock is increased, and the predetermined amount of time for which the transmit data is substituted with fixed data can each be specified arbitrarily. Then, since the response characteristics of the clock recovery section 19 vary depending on the receiver 114, the predetermined amounts of time are preferably sufficiently long so as to accommodate the receiver 114 of the slowest response.

### Second Embodiment

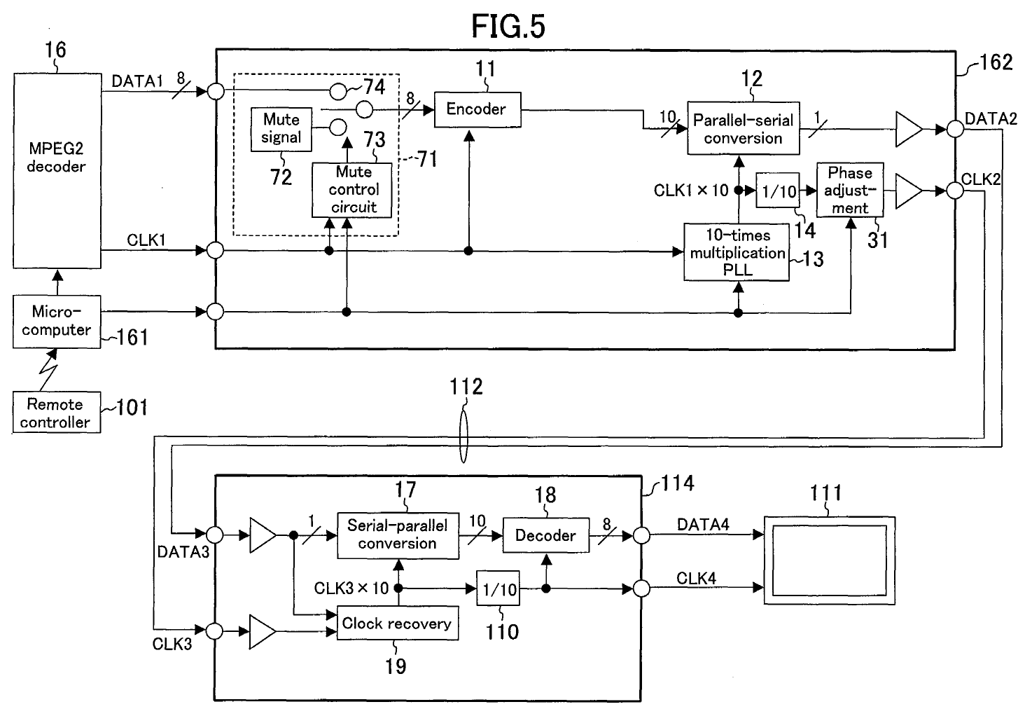

FIG. 5 is a block diagram showing a configuration including a transmitter according to a second embodiment of the present invention. In FIG. 5, like elements to those of FIG. 1 and those of FIG. 8 described above in the background art section are denoted by like reference numerals to those in FIGS. 1 and 8, and will not be further described below. The transmitter 162 does not include the fixed data producing section 61, but instead includes a mute signal producing section 71 capable of setting the input to the encoder 11 to a mute signal as predetermined fixed data. A microcomputer 161 as a control section controls the 10-times multiplication PLL 13, the phase adjustment section 31 and the mute signal producing section 71. The microcomputer 161 operates based on information from the remote controller 101. The mute signal producing section 71, the encoder 11 and the parallel-serial conversion section 12 together form a transmit data producing section.

The mute signal producing section 71 includes a mute signal storing section 72, a mute control circuit 73 and a selection circuit 74. The mute signal stored in the mute signal storing section 72 is herein assumed to be a value such that there are three points of transition from “1” to “0” or from “0” to “1” within 10-bit data being the output of the encoder 11. For example, “37” in hexadecimal is selected so that the output of the encoder 11 is “1010111000” in binary. The mute control circuit 73 controls the selection circuit 74 according to an instruction from the microcomputer 161. Specifically, when instructed to stop (mute) the video signal output, the mute control circuit 73 controls the selection circuit 74 so that the mute signal stored in the mute signal storing section 72 is output during the video-output period being the period excluding the retrace period.

The operation of the configuration of FIG. 5 will be described.

Based on an instruction from the microcomputer 161, an SD signal or an HD signal is output from the MPEG2 decoder 16. An HD signal may be produced from an SD signal by an up-converter.

For example, where the signal is switched from the SD signal to the HD signal, the microcomputer 161 controls the 10-times multiplication PLL 13 to increase the amount of jitter of the multiplied clock CLK1×10 at the point of signal transition, i.e., when switching the frequency of the input clock CLK1 from one to another. The microcomputer 161 controls the phase adjustment section 31 to increase the amount of jitter of the transmit clock CLK2. These operations are similar to the first embodiment and will not be further described below.

At this time, the microcomputer 161 also controls the mute signal producing section 71 to substitute the video signal portion of the input data DATA1 with a mute signal. More specifically, the microcomputer 161 instructs the mute control circuit 73 to mute the output. In response to this instruction, the mute control circuit 73 controls the selection circuit 74 so that the mute signal stored in the mute signal storing section 72 is output during the video-output period being the period excluding the retrace period.

In the DVI standard, a conversion such that the number of alternations between “1”s and “0”s is decreased is performed in the 8-bit-10-bit conversion by the encoder 11 so as to reduce the frequency of alternations between “1”s and “0”s along the transmission line 112. For example, an 8-bit-10-bit conversion is performed so that there are three or less points of transition from “1” to “0” or from “0” to “1” over 10 bits. Since the mute signal is set to “37” in hexadecimal, the output of the encoder 11 is “1010111000” in binary, and there are three points of transition from “1” to “0” or from “0” to “1” over 10 bits.

Thus, by muting the video signal to the predetermined fixed data, the frequency of transitions from “1” to “0” or from “0” to “1” is increased to be ‘always 3 transitions’ from being ‘1 to 3 transitions’ as is during a normal operation. Therefore, it is possible to make unlikely a phenomenon where significant jitters are undesirably masked as described above in the problems to be solved section. Thus, the clock recovery section 19 can be operated correctly, and it is possible to prevent noise from being displayed on the TV 111. Thereafter, the microcomputer 161 can control the mute control circuit 73 so that the input data DATA1 is given as the input to the encoder 11.

While the above description is directed to a case where the signal is switched from the SD signal to the HD signal, the 10-times multiplication PLL 13, the phase adjustment section 31 and the mute signal producing section 71 can be controlled similarly by the microcomputer 161 also when the signal is switched from the HD signal to the SD signal.

Thus, according to the present embodiment, the video signal portion of the transmit data is set to a mute signal upon signal switching so as to increase the frequency of transitions between “0”s and “1”s from that during a normal operation, whereby the clock recovery section 19 of the receiver 114 can be operated correctly. Therefore, it is possible to prevent noise from being displayed on the TV 111.

It is herein assumed that the mute signal stored in the mute signal storing section 72 is set to “37” in hexadecimal, for example. However, the present invention is not limited to this, and it may be any data as long as the frequency of transitions from “1” to “0” or from “0” to “1” in the transmit data is higher than that during a normal operation in which the frequency of the input clock CLK1 is not switched.

While the present embodiment is directed to a case where the 10-times multiplication PLL 13, the phase adjustment section 31 and the mute signal producing section 71 are each controlled, one of them or any combination of two of them may be controlled. For example, the 10-times multiplication PLL 13 may be replaced by a conventional 10-times multiplication PLL and the phase adjustment section 31 may be omitted from the configuration of FIG. 5, wherein only the mute signal producing section 71 is controlled by the microcomputer 161.

In the present embodiment, as in the first embodiment, the microcomputer 161 receives information on the receiver 114 from the remote controller 101 and specifies, according to this information, the predetermined amount of time for which the amount of jitter of the multiplied clock is increased, the predetermined amount of time for which the amount of jitter of the transmit clock is increased, and the predetermined amount of time for which the input data is muted.

First, the user of the transmitter 162 and the receiver 114 uses the remote controller 101 to specify the product manufacturer, i.e., the manufacturer, of the receiver 114. For example, a graphical user interface (hereinafter referred to as a “GUI”) is used to select one from among a list of product manufacturers. The microcomputer 161 processes the GUI to determine the product manufacturer of the receiver 114. The microcomputer 161 has a table defining the correspondence between product manufacturers and predetermined amounts of time for which the input data is muted, and the predetermined amount of time is determined according to the specified product manufacturer. For example, it may be determined to be 100 msec for Product Manufacturer A and 200 msec for Product Manufacturer B. Therefore, the predetermined amount of time for which the input data is muted is optimized for each product manufacturer of the receiver 114. Moreover, the predetermined amount of time for which the amount of jitter of the transmit clock is increased and the predetermined amount of time for which the amount of jitter of the transmit clock is increased can similarly be determined and thus optimized. Thus, the amount of time until a normal image is displayed on the TV 111 is shortened, thereby optimizing the image-output time required before an image is output to the TV 111.

While it is herein assumed that the remote controller 101 is used to specify the product manufacturer of the receiver 114, it may be used to specify the model name, the common name, etc., for example. Thus, the remote controller 101 may be used to specify any information as long as the information specifies the receiver 114.

Instead of using information on the receiver 114, the predetermined amount of time for which the amount of jitter of the multiplied clock is increased, the predetermined amount of time for which the amount of jitter of the transmit clock is increased, and the predetermined amount of time for which the input data is muted can each be specified arbitrarily. Then, since the response characteristics of the clock recovery section 19 vary depending on the receiver 114, the predetermined amounts of time are preferably sufficiently long so as to accommodate the receiver 114 of the slowest response.

### Third Embodiment

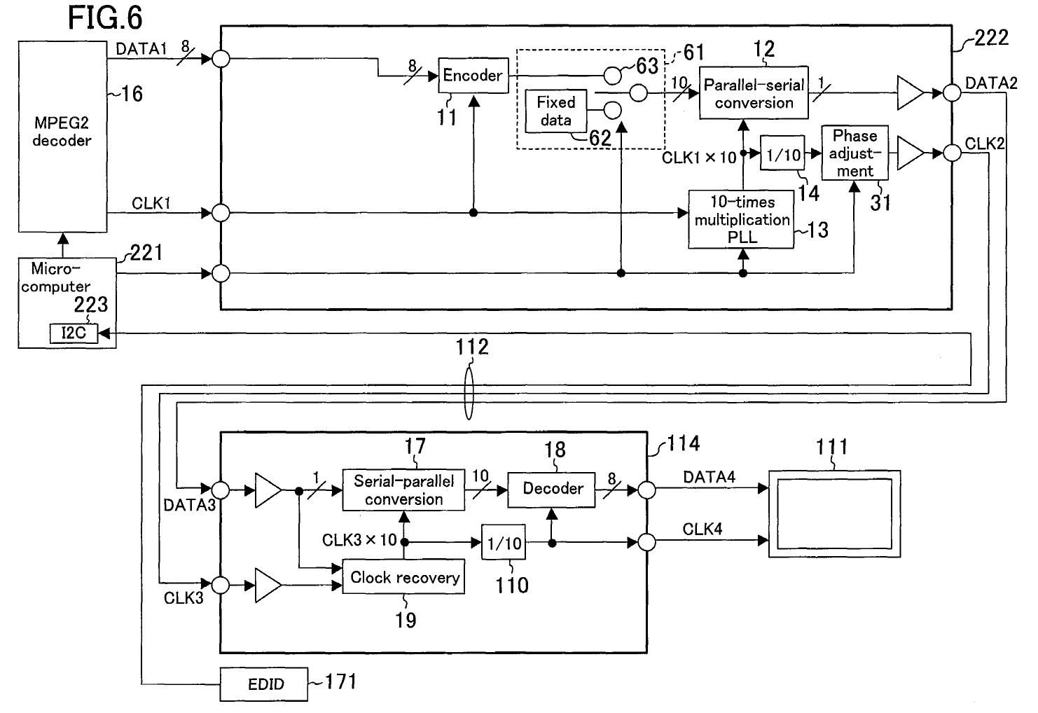

FIG. 6 is a block diagram showing a configuration including a transmitter according to a third embodiment of the present invention. In FIG. 6, like elements to those of FIG. 1 and those of FIG. 8 described above in the background art section are denoted by like reference numerals to those in FIGS. 1 and 8, and will not be further described below.

The operation of the configuration of FIG. 6 is basically the same as that of the configuration of FIG. 1. Specifically, a microcomputer 221 as a control section controls the 10-times multiplication PLL 13, the phase adjustment section 31 and the fixed data producing section 61, as in the first embodiment. What is different from the first embodiment is that the microcomputer 221 operates based on information read out from EDID 171, instead of information from the remote controller 101.

The EDID 171 stores various information on the receiver 114 or the TV 111. For example, the various information recorded include the resolutions with which the TV 111 can produce a display, the audio sample rates with which sound can be output, the product manufacturer, the product number, etc. The microcomputer 221 is provided with read-out means 223 for accessing the EDID 171 via the cable 112 to obtain various information. For example, I2C, being a serial interface, is widely known in the art as such read-out means 223.

Then, according to the information on the receiver 114 read out by the read-out means 223 from the EDID 171, the microcomputer 221 specifies each of the predetermined amount of time for which the amount of jitter of the multiplied clock is increased, the predetermined amount of time for which the amount of jitter of the transmit clock is increased, and the predetermined amount of time for which the transmit data is substituted with fixed data.

Specifically, the microcomputer 221 extracts the product manufacturer of the receiver 114 from the information read out from the EDID 171. The microcomputer 221 has a table defining the correspondence between product manufacturers and predetermined amounts of time for which the amount of jitter of the multiplied clock is increased, and the predetermined amount of time is determined according to the extracted product manufacturer based on this table. For example, it may be determined to be 100 msec for Product Manufacturer A and 200 msec for Product Manufacturer B. Therefore, the amount of time for which the amount of jitter of the multiplied clock is increased is optimized for each product manufacturer of the receiver 114. Moreover, the predetermined amount of time for which the amount of jitter of the transmit clock is increased and the predetermined amount of time for which the transmit data is substituted with fixed data can similarly be determined and thus optimized. Thus, the amount of time until a normal image is displayed on the TV 111 is shortened, thereby optimizing the image-output time required before an image is output to the TV 111.

While it is herein assumed that the predetermined amount of time is specified based on the product manufacturer, it may be specified based on the model name, the common name, etc., for example. Thus, the predetermined amount of time can be specified by reading out from the EDID 171 information based on which the receiver 114 can be specified.

In the configuration of the second embodiment shown in FIG. 5, the microcomputer may specify the predetermined amount of time for which the input data is muted, etc., based on information read out from EDID as in the present embodiment, instead of information from the remote controller.

### Fourth Embodiment

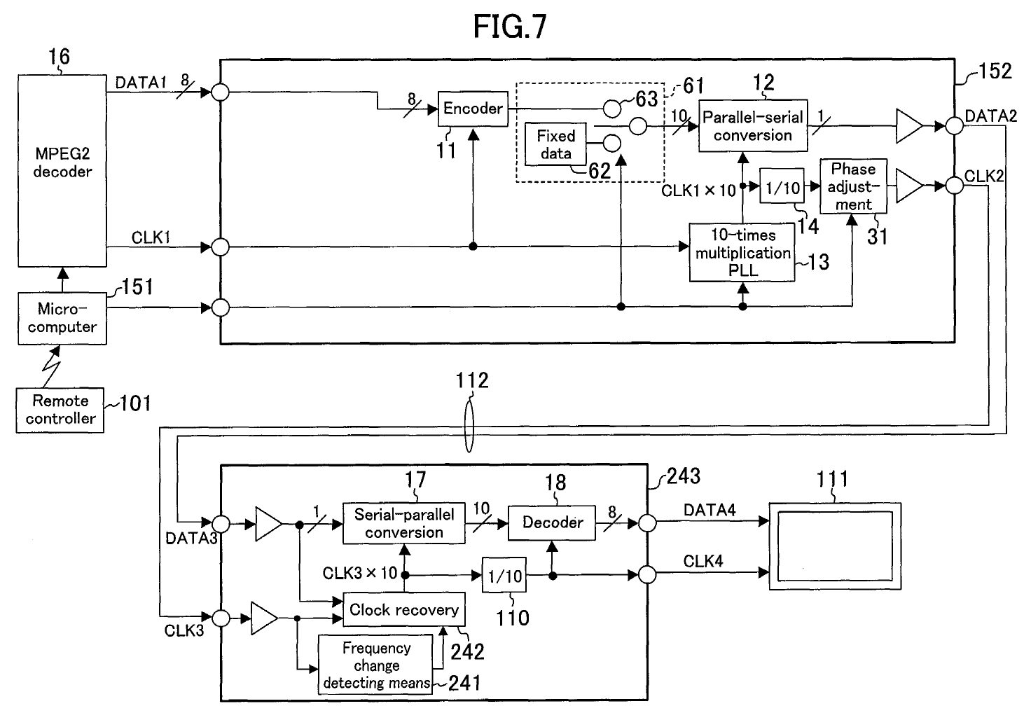

FIG. 7 is a block diagram showing a configuration including a transmitter/receiver according to a fourth embodiment of the present invention. In FIG. 7, like elements to those of FIG. 1 and those of FIG. 8 described above in the background art section are denoted by like reference numerals to those in FIGS. 1 and 8, and will not be further described below.

The configuration and the operation on the side of the transmitter 152 of FIG. 7 are similar to those of the first embodiment shown in FIG. 1, and will not be further described below. What is different from the first embodiment is that the receiver 243 is provided with frequency change detecting means 241.

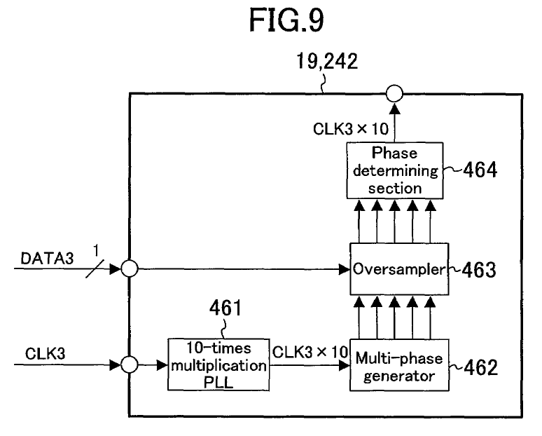

In the receiver 243, a clock recovery section 242 reproduces, from the receive data DATA3 and the receive clock CLK3, a multiplied clock CLK3×10 being in synchronism with the receive data DATA3 and having a frequency that is N times that of the receive clock CLK3 (herein N=10). The internal configuration is similar to that of the clock recovery section 19 shown in FIG. 9. The frequency change detecting means 241 is capable of detecting a change in the frequency of the receive clock CLK3, and resets and initializes the clock recovery section 242 when the change is detected. By this operation, the state of the clock recovery section 242 is reset upon signal switching, thereby preventing the clock recovery from the receive clock CLK3 from starting halfway through, thus optimizing the operation. Thus, it is possible to minimize the amount of time required before selecting a correct clock phase.

For example, in the configuration of FIG. 9, the pull-in time of the 10-times multiplication PLL 461 can be shortened by initializing the oscillation frequency of the 10-times multiplication PLL 461 to near 74.175×10 MHz for the HD signal and near 27×10 MHz for the SD signal. Thus, it is possible to shorten the amount of time required before the clock recovery section 242 selects the correct clock phase.

The frequency change detection by the frequency change detecting means 241 can be realized, for example, by passing the receive clock CLK3 through a low-pass filter. For example, where switching between the SD signal and the HD signal is detected, the cut-off frequency of the low-pass filter can be set to be near 50 MHz. Then, the receive clock CLK3 will pass through when the signal is an SD signal and the receive clock CLK3 will not pass when the signal is an HD signal, whereby it is possible to detect a change in the frequency.

Thus, according to the present embodiment, the receiver 243 is provided with the frequency change detecting means 241 so as to reset the clock recovery section 242 upon detecting a change in the frequency of the receive clock, thereby shortening the amount of time required before a correct clock phase is selected, thus enabling a quick image output to the TV 111.

The configuration on the transmitter side is not limited to that shown in FIG. 7. For example, the receiver may be provided with the frequency change detecting means in the configuration of FIG. 5 or 6, or the receiver may be provided with the frequency change detecting means in a configuration where one of the 10-times multiplication PLL 13, the phase adjustment section 31 and the fixed data producing section 61 or any combination of two of them is controlled.

While it is assumed in the embodiments above that the multiplied clock has a frequency that is 10 times that of the original clock, the present invention is not limited to this.

While the embodiments above are directed to the case of the DVI standard, as an example, similar effects can be obtained also with the HDMI standard by similar configurations and similar operations. Moreover, similar effects can be obtained by similar configurations and similar operations not only with the DVI standard or the HDMI standard, but also with similar transmission/reception schemes.

### INDUSTRIAL APPLICABILITY

The transmitter and the transmitter/receiver of the present invention, being capable of reducing the noise to be displayed on the TV upon signal switching, e.g., from the SD signal to the HD signal, are useful in cases where video/audio signals reproduced by a DVD player, a DVD recorder, or the like, are transmitted to be displayed on a plasma TV or an LCD TV, for example.

1. A transmitter, comprising:
a clock multiplication section for receiving an input clock and producing a multiplied clock having a frequency that is N times that of the input clock (N is a natural number), the clock multiplication section being capable of increasing/decreasing an amount of jitter of the multiplied clock;
a transmit data producing section for receiving input data and producing, from the input data, transmit data being serial data in synchronism with the multiplied clock;
a transmit clock producing section for dividing a frequency of the multiplied clock to 1/N to produce a transmit clock; and
a control section for controlling the clock multiplication section so as to increase an amount of jitter of the multiplied clock for a predetermined amount of time upon switching of a frequency of the input clock.

2. The transmitter of claim 1, wherein:
the clock multiplication section includes:
a phase comparison section for comparing a phase of the input clock and that of a clock obtained by dividing a frequency of the multiplied clock to 1/N;
a filter section for smoothing an output of the phase comparison section, the filter section being capable of switching a passband from one to another; and
an oscillator for producing the multiplied clock while varying an oscillation frequency according to an output of the filter section; and
the filter section switches the passband from one to another according to an instruction from the control section.

3. The transmitter of claim 1, wherein the control section receives from outside information on a receiver to which the transmit data and the transmit clock are transmitted to specify the predetermined amount of time according to the information.

4. The transmitter of claim 1, wherein:
the control section includes read-out means for reading out via a transmission line information on a receiver to which the transmit data and the transmit clock are transmitted; and
the control section specifies the predetermined amount of time according to the information on the receiver read out by the read-out means.

5. The transmitter of claim 3, wherein the information on the receiver at least includes a manufacturer of the receiver.

6. A transmitter, comprising:
a clock multiplication section for receiving an input clock and producing a multiplied clock having a frequency that is N times that of the input clock (N is a natural number);
a transmit data producing section for receiving input data and producing, from the input data, transmit data being serial data in synchronism with the multiplied clock;
a transmit clock producing section for dividing a frequency of the multiplied clock to 1/N to produce a transmit clock, the transmit clock producing section being capable of increasing/decreasing an amount of jitter of the transmit clock; and
a control section for controlling the transmit clock producing section so as to increase an amount of jitter of the transmit clock for a predetermined amount of time upon switching of a frequency of the input clock.

7. The transmitter of claim 6, wherein:
the transmit clock producing section includes a phase adjustment section capable of adding a plurality of different amounts of delay to the transmit clock; and
the phase adjustment section randomly adds the plurality of different amounts of delay to the transmit clock according to an instruction from the control section.

8. The transmitter of claim 6, wherein the control section receives from outside information on a receiver to which the transmit data and the transmit clock are transmitted to specify the predetermined amount of time according to the information.

9. The transmitter of claim 6, wherein:
the control section includes read-out means for reading out via a transmission line information on a receiver to which the transmit data and the transmit clock are transmitted; and
the control section specifies the predetermined amount of time according to the information on the receiver read out by the read-out means.

10. The transmitter of claim 8, wherein the information on the receiver at least includes a manufacturer of the receiver.

11. A transmitter, comprising:
a clock multiplication section for receiving an input clock and producing a multiplied clock having a frequency that is N times that of the input clock (N is a natural number);
a transmit data producing section for receiving input data and producing, from the input data, transmit data being serial data in synchronism with the multiplied clock, wherein the transmit data can be set to predetermined fixed data;
a transmit clock producing section for dividing a frequency of the multiplied clock to 1/N to produce a transmit clock; and
a control section for controlling the transmit data producing section so as to set the transmit data to the predetermined fixed data for a predetermined amount of time upon switching of a frequency of the input clock,
wherein the predetermined fixed data is such data that a frequency of transitions from “1” to “0” or from “0” to “1” in the transmit data becomes higher than that during a normal operation.

12. The transmitter of claim 11, wherein the predetermined fixed data is an alternating string of “1”s and “0”s.

13. The transmitter of claim 11, wherein the control section receives from outside information on a receiver to which the transmit data and the transmit clock are transmitted to specify the predetermined amount of time according to the information.

14. The transmitter of claim 11, wherein:
the control section includes read-out means for reading out via a transmission line information on a receiver to which the transmit data and the transmit clock are transmitted; and
the control section specifies the predetermined amount of time according to the information on the receiver read out by the read-out means.

15. The transmitter of claim 13, wherein the information on the receiver at least includes a manufacturer of the receiver.

16. A transmitter, comprising:
a clock multiplication section for receiving an input clock and producing a multiplied clock having a frequency that is N times that of the input clock (N is a natural number);
a transmit data producing section for receiving input data representing a video signal and producing, from the input data, transmit data being serial data in synchronism with the multiplied clock, wherein the input data can be set to predetermined fixed data;
a transmit clock producing section for dividing a frequency of the multiplied clock to 1/N to produce a transmit clock; and
a control section for controlling the transmit data producing section so that data of the input data excluding retrace periods is set to the predetermined fixed data for a predetermined amount of time upon switching of a frequency of the input clock,
wherein the predetermined fixed data is such data that a frequency of transitions from “1” to “0” or from “0” to “1” in the transmit data becomes higher than that during a normal operation.

17. The transmitter of claim 16, wherein:
N is 10; and
the predetermined fixed data is such data that there are three or more points of transition from “1” to “0” or from “0” to “1” over 10 bits in the transmit data.

18. The transmitter of claim 16, wherein the control section receives from outside information on a receiver to which the transmit data and the transmit clock are transmitted to specify the predetermined amount of time according to the information.

19. The transmitter of claim 16, wherein:
the control section includes read-out means for reading out via a transmission line information on a receiver to which the transmit data and the transmit clock are transmitted; and
the control section specifies the predetermined amount of time according to the information on the receiver read out by the read-out means.

20. The transmitter of claim 18, wherein the information on the receiver at least includes a manufacturer of the receiver.

21. The transmitter of any of claims claims 1, 6, 11 and 16, wherein transmission is done in a DVI standard or an HDMI standard.

22. A transmitter/receiver, comprising:
the transmitter of any of claims claims 1, 6, 11 and 16; and
a receiver for receiving the transmit data and the transmit clock transmitted from the transmitter as receive data and a receive clock, respectively,
wherein the receiver includes:
a clock recovery section for reproducing, from the receive data and the receive clock, a multiplied clock being in synchronism with the receive data and having a frequency that is N times that of the receive clock; and
frequency change detecting means for detecting a switching of a frequency of the receive clock to initialize the clock recovery section upon detection.
